(19) United States
(12) Patent Application Publication
(10) Pub. No.: US 2024/0094582 A1
(43) Pub. Date: Mar. 21, 2024

(54) DISPLAY DEVICE AND HEAD MOUNT DISPLAY

(71) Applicant: Japan Display Inc., Tokyo (JP)

(72) Inventors: Keiji TAGO, Tokyo (JP); Atsuko IMOTO, Tokyo (JP); Kenichi AKUTSU, Tokyo (JP)

(73) Assignee: Japan Display Inc., Tokyo (JP)

(21) Appl. No.: 18/470,569

(22) Filed: Sep. 20, 2023

(30) Foreign Application Priority Data
Sep. 21, 2022 (JP) 2022-150172

(51) Int. Cl. G02F 1/1339; G02B 27/01

(52) U.S. Cl. CPC G02F 1/13394; G02B 27/0172

(57) ABSTRACT

According to one embodiment, a display device includes a first substrate having a display area where a plurality of pixels are arranged, a second substrate opposed to the first substrate, a liquid crystal layer arranged between the first substrate and the second substrate, and spacers holding a gap between the first substrate and the second substrate. The spacers are arranged in the display area. The display area includes a first display area including a center of the display area and a second display area around the first display area. An arrangement density of the spacers in the first display area is smaller than an arrangement density of the spacers in the second display area.

### CROSS-REFERENCE TO RELATED APPLICATIONS

This application is based upon and claims the benefit of priority from Japanese Patent Application No. 2022-150172, filed Sep. 21, 2022, the entire contents of which are incorporated herein by reference.

### FIELD

Embodiments described herein relate generally to a display device and a head mount display.

### BACKGROUND

In recent years, a technique of providing virtual reality (VR) using an electronic device referred to as a head mount display (HMD), which is worn on a user's head, has been focused.

In accordance with this, implementation of a display device which can be mounted on such an HMD and which can provide the user with high-quality display has been required.

### BRIEF DESCRIPTION OF THE DRAWINGS

FIG. 1 is a view showing a mounting example of a display device according to one of embodiments.

FIG. 2 is a schematic plan view showing the display device according to the embodiment.

FIG. 3 is a plan view schematically showing an example of a sub-pixel according to the embodiment.

FIG. 4 is a schematic cross-sectional view showing the display panel along line a-a′ in FIG. 3.

FIG. 5 is a view illustrating a shape and an arrangement example of a color filter according to the embodiment.

FIG. 6 is a view illustrating a shape and an arrangement example of a color filter according to the embodiment.

FIG. 7 is a view illustrating a shape and an arrangement example of a spacer according to the embodiment.

FIG. 8 is a view illustrating a shape and an arrangement example of a spacer according to the embodiment.

FIG. 9 is a schematic cross-sectional view showing the display panel along line b-b′ in FIG. 8.

FIG. 10 is a view illustrating a spacer of a cross column arrangement according to the embodiment.

FIG. 11 is a view illustrating a shape and an arrangement example of a spacer according to the embodiment.

FIG. 12 is a view illustrating a shape and an arrangement example of a spacer according to the embodiment.

FIG. 13 is a view illustrating a shape and an arrangement example of a spacer according to the embodiment.

FIG. 14 is a view illustrating a shape and an arrangement example of a spacer according to the embodiment.

FIG. 15 is a view illustrating a shape and an arrangement example of a spacer according to the embodiment.

FIG. 16 is a view illustrating a shape and an arrangement example of a spacer according to the embodiment.

FIG. 17 is a view illustrating a shape and an arrangement example of a spacer according to the embodiment.

FIG. 18 is a view illustrating a shape and an arrangement example of a spacer according to the embodiment.

### DETAILED DESCRIPTION

In general, according to one embodiment, a display device includes a first substrate having a display area where a plurality of pixels are arranged, a second substrate opposed to the first substrate, a liquid crystal layer arranged between the first substrate and the second substrate, and spacers holding a gap between the first substrate and the second substrate. The spacers are arranged in the display area. The display area includes a first display area including a center of the display area and a second display area around the first display area. An arrangement density of the spacers in the first display area is smaller than an arrangement density of the spacers in the second display area.

Embodiments will be described hereinafter with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by like reference numerals and their detailed descriptions may be omitted unless necessary.

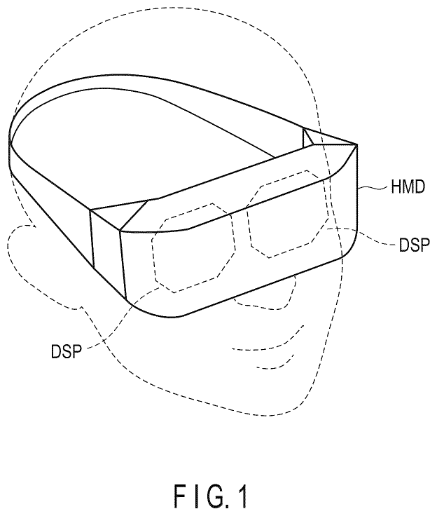

FIG. 1 is a view showing a mounting example of a display device according to one of embodiments.

In the embodiment, for example, display devices DSP are mounted on a head mount display (HMD) worn on a user's head. HMD is used to provide the user wearing the HMD on with virtual reality (VR).

The display devices DSP are arranged to be located in front of user's right and left eyes when the user wears the HMD. In other words, when the display devices DSP are mounted on the HMD, two display devices DSP for right and left eyes are mounted on the HMD. In the embodiment, the display device DSP which can be mounted on the HMD and which can be used as a VR viewer will be described.

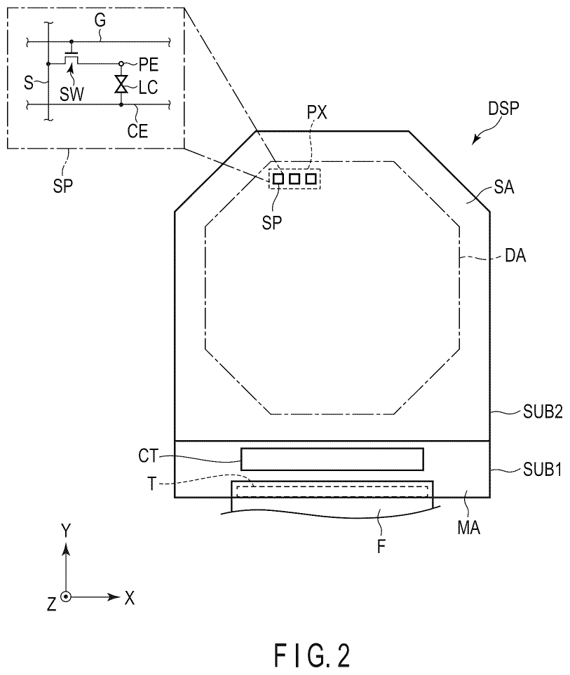

FIG. 2 is a schematic plan view of the display device DSP. In the embodiment, an X direction, a Y direction, and a Z direction are defined as shown in FIG. 2. The X direction, the Y direction, and the Z direction are, for example, directions orthogonal to one another but may intersect at an angle other than an orthogonal angle. A direction indicated by an arrow of the Z direction is referred to as “above/over”, and an opposite direction of the arrow is referred to as “under/below” in some cases. In addition, viewing the display device DSP and its components parallel to the Z direction is referred to as plan view.

The display device DSP comprises a display panel PNL and a flexible printed circuit F connected to the display panel PNL.

The display panel PNL is a transmissive liquid crystal display panel, and comprises a first substrate SUB1, a second substrate SUB2 opposed to the first substrate SUB1, and a liquid crystal layer LC sealed between these substrates SUB1 and SUB2. FIG. 2 shows a case where the first substrate SUB1 and the second substrate SUB2 are formed in a hexagonal shape, but the first substrate SUB1 and the second substrate SUB2 may be formed in a rectangular shape, any polygonal shape, or a circular shape.

The display panel PNL has a display area DA where images are displayed, and a surrounding area SA around the display area DA. FIG. 2 shows a case where the display panel PNL has a display area DA in an octagonal shape, but the display area DA may be formed in a rectangular shape, any polygonal shape, or a circular shape. In addition, in the example of FIG. 2, a lower side of the first substrate SUB1 in the figure protrudes beyond the second substrate SUB2 in the Y direction. A mounting area MA which does not overlap with the second substrate SUB2 is thereby formed on the first substrate SUB1. The mounting area MA is a part of the surrounding area SA.

A plurality of pixels PX are arrayed in a matrix in the display area DA. Each pixel PX includes, for example, a plurality of sub-pixels SP displaying red, green, and blue. The pixel PX may include a sub-pixel SP displaying the other color such as white. As shown and enlarged in FIG. 2, the sub-pixels SP (pixel PX) comprises a switching element SW, a pixel electrode PE, a common electrode CE, a liquid crystal layer LC, and the like.

The switching element SW is constituted by, for example, a thin-film transistor (TFT) and is electrically connected to a pixel electrode PE, a scanning line G, and a signal line S. The scanning line G is electrically connected to the switching element SW in each of the sub-pixels SP arranged in the X direction. The signal line S is electrically connected to the switching element SW in each of the sub-pixels SP arranged in the Y direction. When a scanning signal is supplied to the scanning line G, the switching element SW supplies a video signal of the signal line S to the pixel electrode PE. The common electrode CE is formed over a plurality of pixels. The pixel electrode PE is opposed to the common electrode CE and, when the video signal is supplied to the pixel electrode PE, a potential difference is formed between the pixel electrode PE and the common electrode CE, and an electric field thereby generated acts on the liquid crystal layer LC.

In the example of FIG. 2, a controller CT is mounted on the mounting area MA. In addition, a terminal portion T is provided in the mounting area MA, and the flexible printed circuit F is connected to the terminal portion T. Incidentally, the controller CT may be mounted on the flexible printed circuit F. The controller CT can be composed of IC and various circuit elements.

The flexible printed circuit F inputs various signals sent from the substrate of the electronic device (for example, HMD) on which the display device DSP is mounted, and the like, to the controller CT. The controller CT controls an operation of a selector circuit (not shown) which supplies the video signal to the signal line S and controls an operation of a scanning driver (not shown) which supplies the scanning signal to the scanning line G, based pm the input signals.

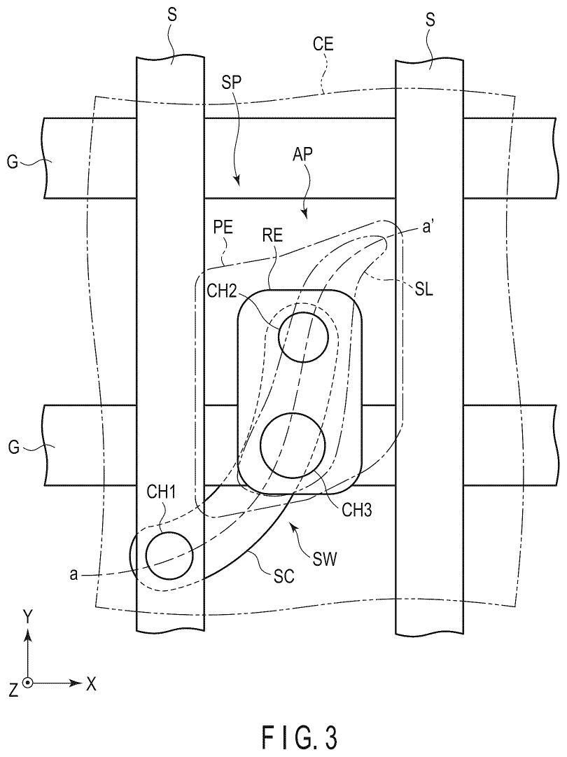

FIG. 3 is a plan view schematically showing an example of the sub-pixel SP. The first substrate SUB1 comprises a plurality of scanning lines G and a plurality of signal lines S. The plurality of scanning lines G extend in the X direction and are arranged in the Y direction. The plurality of signal lines S extend in the Y direction and are arranged in the X direction. An area surrounded by two adjacent scanning lines G and two adjacent video lines S corresponds to an aperture portion (aperture area) AP of one sub-pixel SP.

The first substrate SUB1 comprises the pixel electrode PE, the switching element SW, a relay electrode RE, and the like provided for each sub-pixel SP. The switching element SW includes a semiconductor layer SC. The semiconductor layer SC, the relay electrode RE, the pixel electrode PE, and the common electrode CE are stacked in this order in the Z direction. In FIG. 3, the pixel electrode PE and the common electrode CE are represented by chained lines.

The signal lines S and the semiconductor layer SC are in contact with each other through a first contact hole CH1. The semiconductor layer SC and the relay electrode RE are in contact with each other through a second contact hole CH2. The relay electrode RE and the pixel electrode PE are in contact with each other through a third contact hole CH3.

The semiconductor layer SC is curbed in an arc shape to intersect the scanning line G once, between the first contact hole CH1 and the second contact hole CH2. In the example shown in FIG. 3, the semiconductor layer SC is located under the scanning line G. In contrast, the relay electrode RE is located above the scanning line G except a part inside the second contact hole CH2. The relay electrode RE is formed in, for example, a rectangular shape having rounded corners and overlaps with both the aperture portion AP and the scanning line G.

The pixel electrode PE is larger in area than the relay electrode RE and overlaps with a most part of the aperture portion AP. In the example shown in FIG. 3, the pixel electrode PE overlaps with the scanning line G at the lower stage in the figure (i.e., the scanning line G intersecting the semiconductor layer SC of the sub-pixels SP), but does not overlap with the scanning line G at the upper stage in the figure.

The common electrode CE includes a slit SL in each of the sub-pixels SP. Incidentally, in FIG. 3, the only slit SL of one sub-pixel SP is shown, and slits SL of the other sub-pixels SP adjacent to the sub-pixel SP are omitted. At least a part of the slit SL is curved along a diagonal line of the sub-pixel SP. The slit SL entirely overlaps with the pixel electrode PE. In the example shown in FIG. 3, the slit SL overlaps with the scanning line G at the lower stage in the figure (i.e., the scanning line G intersecting the semiconductor layer SC of the sub-pixel SP), but does not overlap with the scanning line G at the upper stage in the figure or each of the signal lines S. In addition, the slit SL overlaps with each of the second contact hole CH2 and the third contact hole CH3, and also overlaps with the semiconductor layer SC and the aperture portion AP.

The second contact hole CH2 is located in the aperture portion AP to overlap the pixel electrode PE and the slit SL. In addition, the third contact hole CH3 overlaps with the semiconductor layer SC, the scanning line G, and the slit SL. From the other viewpoint, the third contact hole CH3 overlaps with an area where the scanning line G intersects the semiconductor layer SC.

The shapes of the semiconductor layer SC, the relay electrode RE, the pixel electrode PE, and the slit SL are not limited to those shown in FIG. 3, but various other shapes can be applied. In addition, the positions of the first contact hole CH1, the second contact hole CH2, and the third contact hole CH3 can also be modified appropriately.

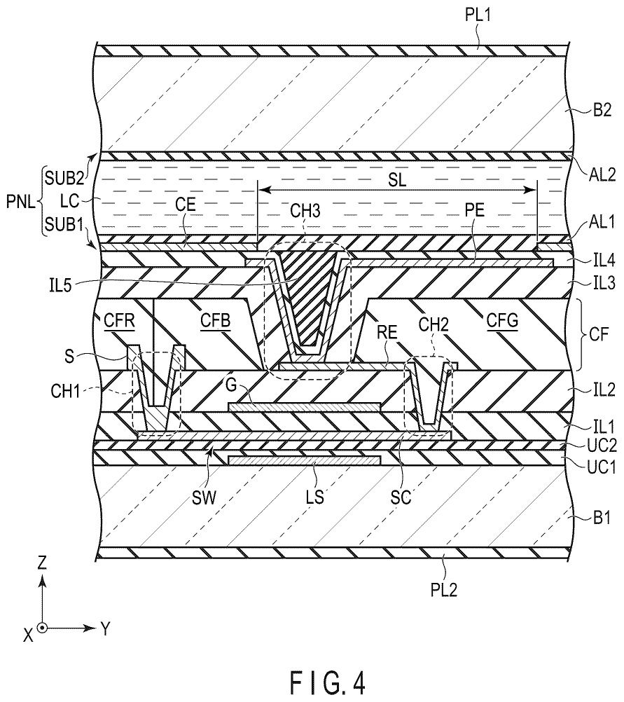

FIG. 4 is a schematic cross-sectional view showing the display panel PNL along line a-a′ in FIG. 3. The first substrate SUB1 comprises the semiconductor layer SC, the scanning line G, the signal line S, the relay electrode RE, the pixel electrode PE, and the common electrode CE as described above. Furthermore, the first substrate SUB1 comprises a first base B1, a light shielding layer LS, a first undercoat layer UC1, a second undercoat layer UC2, a first insulating layer IL1, a second insulating layer IL2, a third insulating layer IL3 (planarization film), a fourth insulating layer IL4, a fifth insulating layer IL5 (planarization film), a color filter layer CF, and a first alignment film AL1.

The light shielding layer LS is provided on an upper surface of the first base B1. The first undercoat layer UC1 covers upper surfaces of the light shielding layer LS and the first base B1. The second undercoat layer UC2 covers the first undercoat layer UC1. The semiconductor layer SC is provided on the second undercoat layer UC2. The area where the semiconductor layer SC intersects the scanning line G is opposed to the light shielding layer LS. The first insulating layer IL1 covers the semiconductor layer SC and the second undercoat layer UC2. The scanning line G is provided on the first insulating layer IL1. The second insulating layer IL2 covers the scanning line G and the first insulating layer IL1.

The signal line S and the relay electrode RE are provided on the second insulating layer IL2. The color filter layer CF covers the signal line S, the relay electrode RE, and the second insulating layer IL2. The third insulating layer IL3 covers the relay electrode RE, the second insulating layer IL2, and the color filter layer CF. The pixel electrode PE is provided on the third insulating layer IL3. The fourth insulating layer IL4 covers the pixel electrode PE and the third insulating layer IL3. The fifth insulating layer IL5 is arranged inside the third contact hole CH3 to planarize a step caused by the third contact hole CH3. The common electrode CE is provided on the fourth insulating layer IL4 to extend over a plurality of sub-pixels SP. The common electrode CE includes the above-described slit SL. The first alignment film AL1 covers the common electrode CE, the fourth insulating layer IL4, and the fifth insulating layer IL5.

The second substrate SUB2 comprises a second base B2 and a second alignment film AL2. The second alignment film AL2 covers a lower surface of the second base B2. The above-described liquid crystal layer LC is arranged between the first alignment film AL1 and the second alignment film AL2.

A first polarizer PL1 is arranged on an upper surface of the second base B2. A second polarizer PL2 is arranged on a lower surface of the first base B1. Absorption axes of the first polarizer PL1 and the second polarizer PL2 are orthogonal to each other. For example, the absorption axis of the first polarizer PL1 is parallel to an initial alignment direction of liquid crystal molecules and, in this case, a normally black display device DSP can be obtained.

The above-described first base B1 and second base B2 can be formed of, for example, borosilicate glass having a thickness of approximately 0.2 mm, but may be formed of resin such as polyimide. The first alignment film AL1 and the second alignment film AL2 are, for example, polyimide films subjected to rubbing alignment treatment.

The first undercoat layer UC1 is, for example, a silicon oxide film. The second undercoat layer UC2 is, for example, a silicon nitride film. The first insulating layer IL1 is, for example, a silicon oxide film. The second insulating layer IL2 is, for example, a silicon nitride film. The third insulating layer IL3 is formed using a transparent positive photoresist. The fourth insulating layer IL4 is, for example, a silicon nitride film formed at a low temperature. The fifth insulating layer IL5 is formed using a transparent positive photoresist.

A plurality of color filters corresponding to each of a plurality of sub-pixels SP are arranged in the color filter layer CF. More specifically, the plurality of color filters arranged in the color filter layer CF includes a color filter CFR corresponding to the sub-pixel SP displaying red, a color filter CFG corresponding to the sub-pixel SP displaying green, and a color filter CFB corresponding to the sub-pixel SP displaying blue. The color filter CFR is arranged at a position overlapping with the sub-pixel SP displaying red, the color filter CFG is arranged at a position overlapping with the sub-pixel SP displaying green, and the color filter CFB is arranged at a position overlapping with the sub-pixel SP displaying blue.

The color filters CFR, CFG, and CFB are formed of negative photoresists containing red, green, and blue pigments, respectively.

The relay electrode RE, the pixel electrodes PE, and the common electrode CE are formed of, for example, a transparent conductive material such as indium tin oxide (ITO). The scanning line G and the light shielding layer LS are formed of, for example, a molybdenum tungsten alloy. The signal line S has, for example, a three-layer structure formed by stacking titanium, aluminum, and titanium in order. The semiconductor layer SC is, for example, a metal oxide semiconductor containing indium zinc oxide (IZO).

Each element of the first substrate SUB1 and the second substrate SUB2 is not limited to the materials exemplified above, but can be formed of various materials. For example, the semiconductor layer SC is not limited to an oxide semiconductor, but may be formed of polysilicon or amorphous silicon.

Each of the first contact hole CH1 and the second contact hole CH2 penetrates the first insulating layer IL1 and the second insulating layer IL2. The third contact hole CH3 penetrates the third insulating layer IL3. The signal line S is in contact with the semiconductor layer SC through the first contact hole CH1. The relay electrode RE is in contact with the semiconductor layer SC through the second contact hole CH2. The pixel electrode PE is in contact with the relay electrode RE through the third contact hole CH3.

The structure of the display panel PNL is not limited to the example shown in FIG. 4. In the example shown in FIG. 4, the common electrode CE is located between the pixel electrode PE and the liquid crystal layer LC but, for example, the pixel electrode PE and the common electrode CE may be arranged in the same layer or the pixel electrode PE may be arranged between the liquid crystal layer LC and the common electrode CE. Alternatively, the common electrode CE may be arranged in the the second substrate SUB2. Moreover, the display panel PNL can be modified in various aspects.

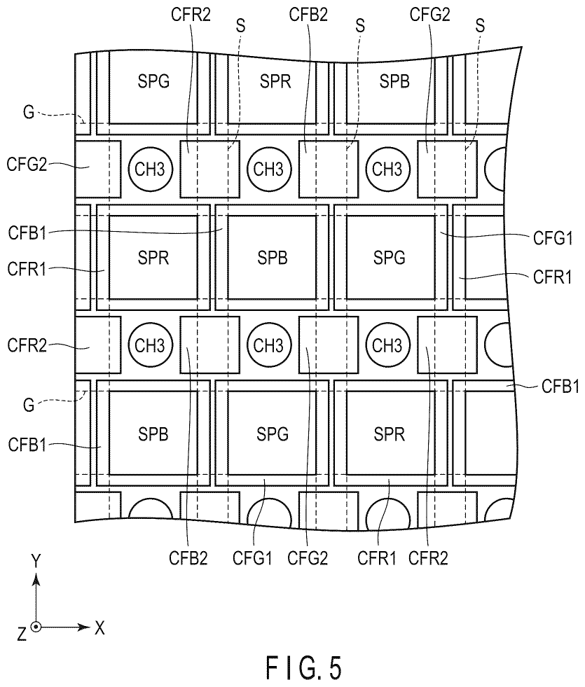

FIG. 5 is a view illustrating the shape and arrangement of the color filters CFR, CFG, and CFB. The color filters CFR, CFG, and CFB are formed to correspond to the sub-pixel SPR displaying red, the sub-pixel SPG displaying green, and the sub-pixel SPB displaying blue. The sub-pixels SPR, SPG, and SPB shown in FIG. 5 indicate aperture portions (aperture areas) of each of the sub-pixels SP divided by the scanning lines G and the signal lines S.

For example, the color filter CFB shown in FIG. 5 is composed of two large and small island-shaped structures. More specifically, the color filter CFB includes a first filter portion CFB1 formed at a position which overlaps with the aperture portion of the sub-pixel SPB in plan view, and a second filter portion CFB2 formed at a position which overlaps with a non-aperture portion (i.e., an area other than the aperture portion) of the sub-pixel SPB in plan view. More specifically, the second filter portion CFB2 is formed in an area where the scanning line G intersects the signal line S.

Each of the first filter portion CFB1 and the second filter portion CFB2 has a rectangular shape, and area of the second filter portion CFB2 is smaller than area of the first filter portion CFB1. However, one or both of the first filter portion CFB1 and the second filter portion CFB2 are not limited to a rectangular shape, but may include a portion where corner portions of the rectangle are rounded, may have a polygonal island-shaped structure or a circular island-shaped structure.

In the example shown in FIG. 5, all the color filters CFB corresponding to each of a plurality of sub-pixels SPB are formed to be a planar shape including the above-described first filter portions CFB1 and second filter portions CFB2.

In the embodiment, the plurality of sub-pixels SPB (color filters CFB) are adjacent to each other in a direction oblique to the X direction and the Y direction in which the plurality of sub-pixels SP (pixels PX) are aligned. The direction in which the plurality of sub-pixels SPB are adjacent to each other corresponds to a direction in which, for example, a center of the aperture portion (first filter portion CFB1) in each of the plurality of sub-pixels SPB is arranged. In the example shown in FIG. 5, the plurality of sub-pixels SPB are adjacent to each other in a direction from a lower left side to an upper right side, and the plurality of first filter portions CFB1 and the plurality of second filter portions CFB2 corresponding to the plurality of sub-pixels SPB are also adjacent to each other in the direction from the lower left side to the upper right side.

The color filters CFB have been described here, but the other color filters CFR and CFG also have a planar shape similarly to the color filters CFB, and are arranged similarly to the color filters CFB. Each of the plurality of color filters CFR includes a first filter portion CFR1 and a second filter portion CFR2, and each of the plurality of color filters CFG includes a first filter portion CFR1 and a second filter portion CFR2.

In addition, the third contact hole CH3 is formed between the second filter portions included in the color filters corresponding to each of two sub-pixels SP adjacent to each other in the X direction. In other words, the third contact hole CH3 is formed in a gap portion surrounded by the color filters CFR, CFG, and CFB (two first color filter portions and two second color filter portions).

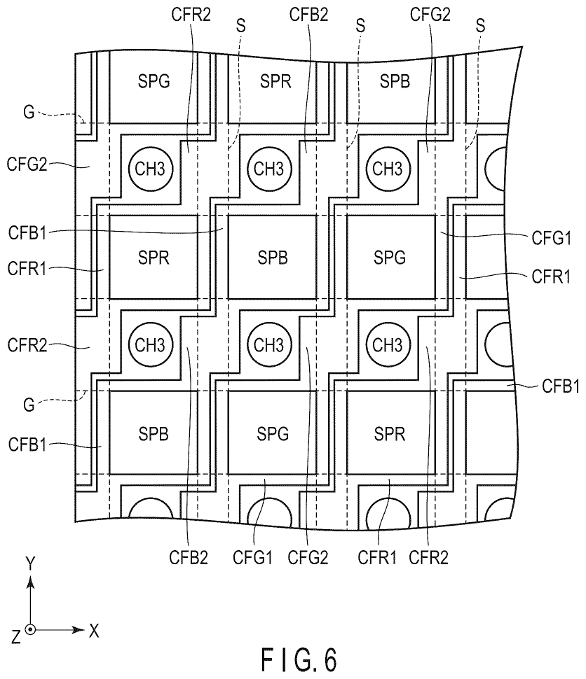

It has been described that each of the color filters CFR, CFG, and CFB includes two large and small island shapes and that, for example, the first filter portion CFB1 and the second filter portion CFB2 included in the color filter CFB are arranged to be separated from each other in FIG. 5, but the first filter portion CFB1 and the second filter portion CFB2 may be arranged to be connected in a shape of stairs as shown in FIG. 6. Moreover, the color filters CFR, CFG, and CFB can be arranged in various aspects.

Incidentally, although not shown in FIG. 2 to FIG. 6, a spacer is arranged between the first substrate SUB1 and the second substrate SUB2, as a retaining member which retains a gap between the first substrate SUB1 and the second substrate SUB2 forming the liquid crystal layer LC. A thickness (cell gap) of the liquid crystal layer LC can be made uniform and a gap abnormality can be suppressed by arranging the spacer between the first substrate SUB1 and the second substrate SUB2. In contrast, when the spacer is arranged between the first substrate SUB1 and the second substrate SUB2, alignment failure that the alignment direction of the liquid crystal molecules around the spacer does not match the alignment direction of the other liquid crystal molecules occurs. Since such an alignment failure causes light leakage and results in the degradation in display quality, a light shielding member (light shielding layer) is generally arranged at a position which overlaps with the spacer. However, since the display device used as a VR viewer displays with high definition, the aperture ratio of the pixels may be remarkably degraded if the light shielding member is arranged at the position which overlaps with the spacer. In contrast, if the light shielding member is not arranged at the position which overlaps with the spacer, light leakage resulting from the alignment failure occurs and the contrast ratio is degraded as described above, and the user cannot be therefore provided of high-quality display. Thus, the display device DSP of the embodiment is configured to provide the user of high-quality display as a high-definition display device used as a VR viewer.

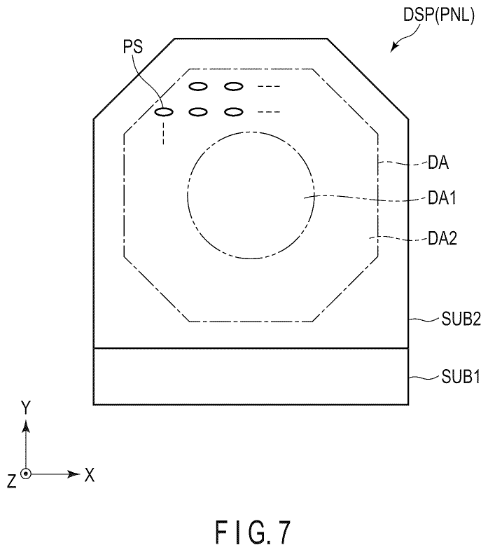

FIG. 7 is a view illustrating the arrangement of spacers PS on the display panel PNL. As shown in FIG. 7, the display panel PNL has an octagonal display area DA. The display area DA includes a first display area DA1 and a second display area DA2. The first display area DA1 is a circular area including the center of the display area DA, and an area where the user's line of sight is easily concentrated when the display device DSP is used as a VR viewer (for example, when the display device DSP is mounted on the HMD shown in FIG. 1). The second display area DA2 is an area around the first display area DA1, and an area where the user's line of sight is rarely concentrated when the display device DSP is used as a VR viewer. Although described later in detail, the size (area) of the first display area DA1 may be any size as long as the gap between the first substrate SUB1 and the second substrate SUB2 can be held appropriately by the spacers PS arranged in the second display area DA2.

As shown in FIG. 7, the display panel PNL is configured such that the spacers PS are arranged in the second display area DA2 where the user's line of sight is rarely concentrated and that the spacers PS are not arranged in the first display area DA1 where the user's line of sight is concentrated. Incidentally, the spacers PS are arranged in the second display area DA2 such that the gap between the first substrate SUB1 and the second substrate SUB2 can be held appropriately.

According to the configuration shown in FIG. 7, since the spacers PS are not arranged in the first display area DA1, the alignment failure which results from the arrangement of the spacers PS does not occur in the first display area DA1. For this reason, the light leakage which results from the alignment failure does not occur in the first display area DA1 where the user's line of sight is easily concentrated, and the user can be provided of the high-quality display. In contrast, since the spacers PS are arranged in the second display area DA2 to appropriately hold the gap between the first substrate SUB1 and the second substrate SUB2, the alignment failure which results from the arrangement of the spacers PS occurs. For this reason, in the second display area DA2, the light leakage which results from the above-described alignment failure occurs and the contrast ratio in the second display area DA2 is degraded (i.e., the contrast ratio in the second display area DA2 becomes lower than the contrast ratio in the first display area DA1). However, since the second display area DA2 is the area where the user's line of sight is rarely concentrated, small degradation in the contrast ratio does not have much influence on the display quality of the VR viewer.

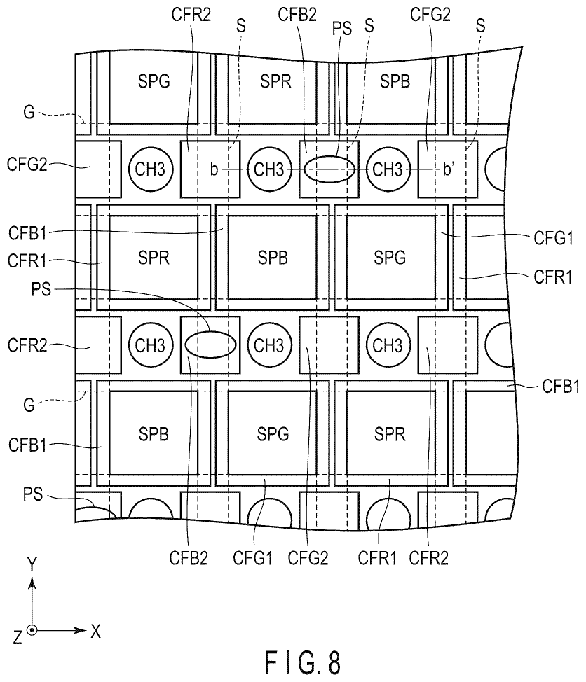

The arrangement of the spacers PS in the second display area DA2 will be described with reference to FIG. 8. As shown in FIG. 8, the spacers PS are formed in a shape of, for example, an elliptic cylinder, and are arranged at positions which overlap with the second filter portions CFB2 constituting the blue color filters CFB. In the example shown in FIG. 8, one spacer PS is not arranged for all the sub-pixels SP, but one spacer PS is arranged for three sub-pixels SP. Incidentally, the spacers PS do not need to be arranged at the positions overlapping with all the second filter portion CFB2 in the second display area DA2, but may be arranged at the positions where the gap between the first substrate SUB1 and the second substrate SUB2 can be held appropriately. In addition, the spacers may be arranged at the positions overlapping with the second filter portions CFR2 constituting the red color filters CFR or the positions overlapping with the second filter portions CFG2 constituting the green color filters CFG.

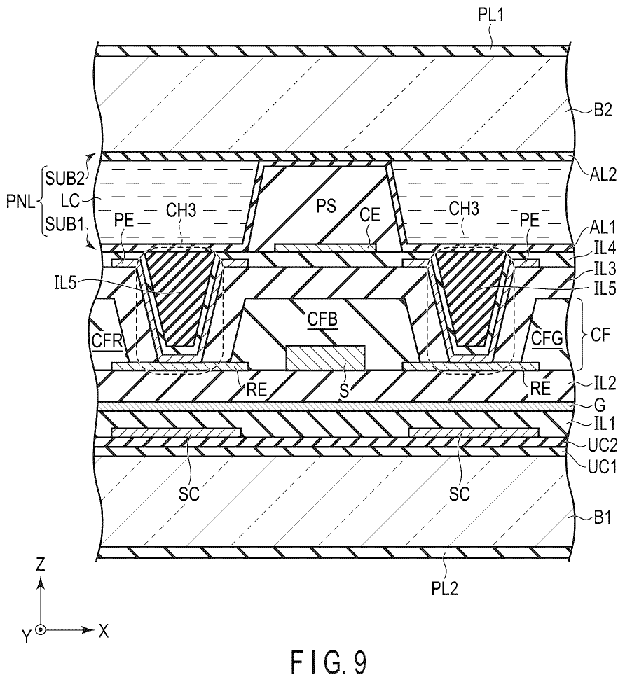

FIG. 9 is a schematic cross-sectional view showing the display panel PNL along line b-b′ in FIG. 8. Incidentally, the elements other than the spacer PS have been described with reference to FIG. 4 described above, and their detailed description is omitted.

As shown in FIG. 9, the spacer PS is arranged at the position which overlaps with (the second filter portion CFB2 included in) the color filter CFB. From the other viewpoint, the spacer PS is arranged between two third contact holes CH3. The size (area) of the elliptic upper surface of the spacer PS is smaller than the elliptic lower surface of the spacers PS, and the cross-sectional shape of the spacer PS is a trapezoid.

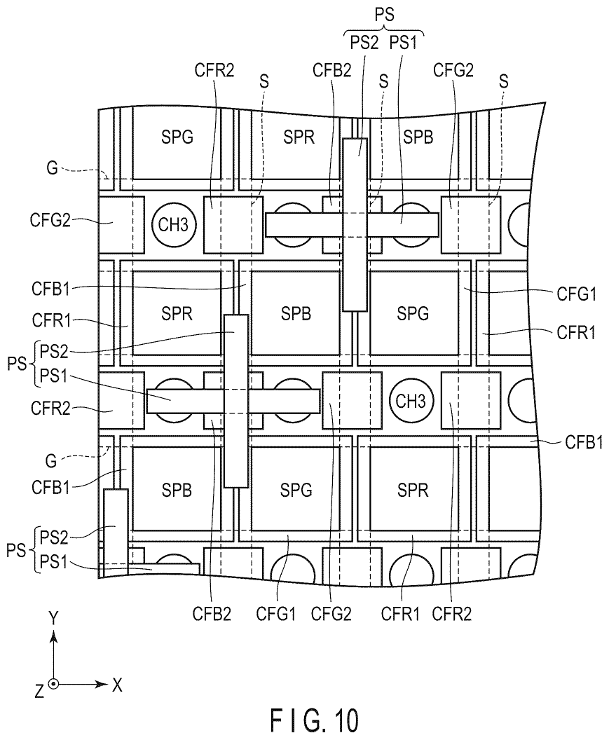

Incidentally, as shown in FIG. 8 and FIG. 9, it has been described that the spacer PS is formed in a shape of an elliptic cylinder, but the spacer PS may be formed in the other shape. More specifically, the spacers PS may be formed as spacers PS in a cross column arrangement as shown in FIG. 10. The spacer PS in the cross column arrangement has a structure in which, for example, a first spacer PS1 extending in the X direction similarly to the scanning line G formed on the first substrate SUB1 side and a second spacer PS2 extending in the Y direction similarly to the signal line S formed on the second substrate SUB2 side are brought into contact with each other in a cross shape. Incidentally, the first spacer PS1 and the second spacer PS2 constituting the spacer PS in the cross column arrangement may not be in contact with each other. The spacer PS in the cross column arrangement can suppress the degree of the alignment failure which results from the arrangement of the spacers PS, as compared with the spacer PS in the shape of the elliptic cylinder.

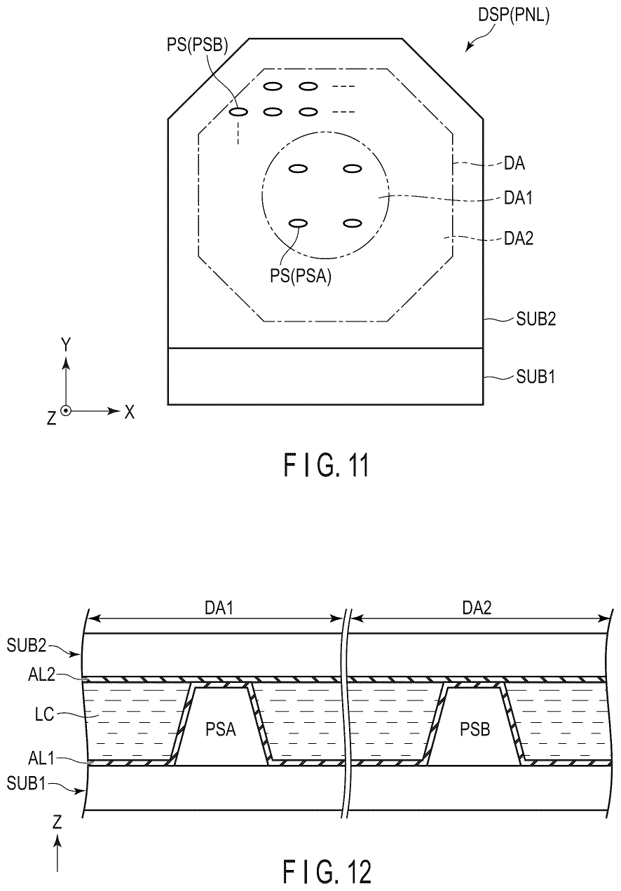

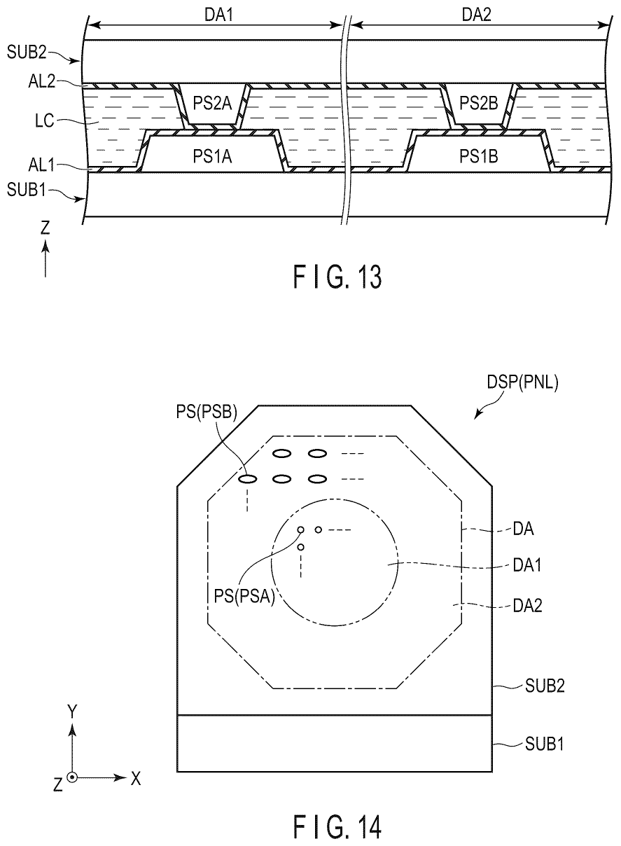

In the above-described embodiment, in high-definition display device used as the VR viewer, the spacers PS are not arranged in the first display area DA1 where the user's line of sight is easily concentrated as the configuration capable of providing the user of high-quality display, but the configuration is not limited to this, and a smaller number of spacers PS (spacers PSA) may be arranged in the first display area DA1 than those in the second display area DA2 as shown in, for example, FIG. 11. For example, the number of spacers PS (spacers PSA) which does not have much influence on the display quality are arranged in the first display area DA1. The spacers PSA and PSB arranged in the first display area DA1 and the second display area DA2 may be formed as spacers having a shape of an elliptic cylinder as shown in FIG. 12 or may be formed as spacers in the cross column arrangement as shown in FIG. 13.

According to the configurations shown in FIG. 11 to FIG. 13, even if the number of spacers PS (spacers PSB) arranged in the second display area DA2 is smaller than that in the configuration shown in FIG. 7, the gap between the first substrate SUB1 and the second substrate SUB2 can be held appropriately since the spacers (spacers PSA) are arranged in the first display area DA1. In addition, according to the configurations shown in FIG. 11 to FIG. 13, since the number of spacers PS (spacers PSB) arranged in the second display area DA2 can be made smaller than that in the configuration shown in FIG. 7 as described above, the contrast ratio of the second display area DA2 can be improved more than that in the configuration shown in FIG. 7 while suppressing the degradation in contrast ratio of the first display area DA1 to the minimum limit. In other words, a difference between the display quality in the first display area DA1 and the display quality in the second display area DA2 can be reduced as compared with the configuration shown in FIG. 7.

In the above-described embodiment, in high-definition display device used as the VR viewer, the spacers PS are not arranged in the first display area DA1 where the user's line of sight is easily concentrated as the configuration capable of providing the user of high-quality display, but the configuration is not limited to this, and the spacers PS (spacers PSA) having a different size (different shape) than that of the spacers in the second display area DA2 may be arranged in the first display area DA1 as shown in, for example, FIG. 14. For example, the spacers PS (spacers PSA) having the size (shape) which does not have much influence on the display quality are arranged in the first display area DA1.

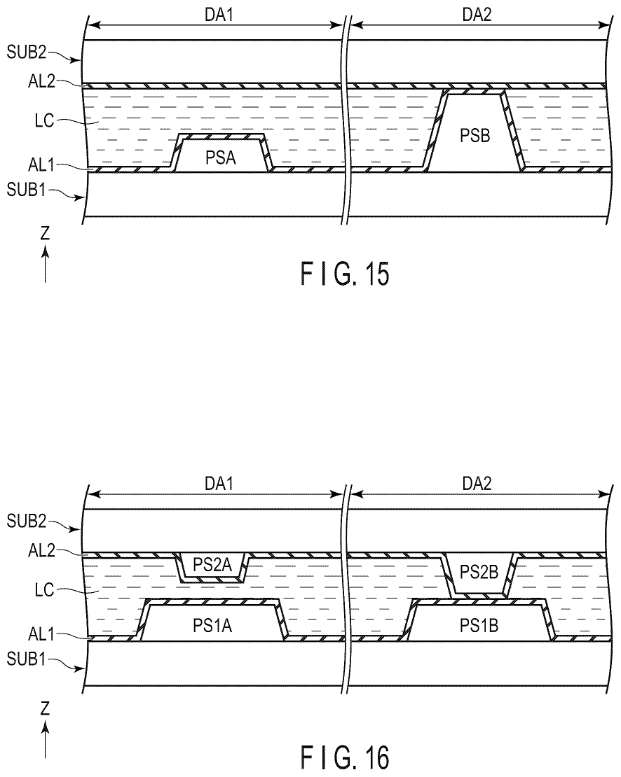

Specifically, as shown in FIG. 15, spacers PS having different heights may be arranged in the first display area DA1 and the second display area DA2. More specifically, a spacer PSA which is smaller (lower) in height than a spacer PSB arranged in the second display area DA2 may be arranged in the first display area DA1 where the user's line of sight is easily concentrated, and a spacer PSB which is larger (higher) in height than a spacer PSA arranged in the first display area DA1 may be arranged in the second display area DA2 where the user's line of sight is rarely concentrated. In this case, the spacer PSA arranged in the first display area DA1 is not in contact with the configuration on the second substrate SUB2 side, but is separated from the configuration on the second substrate SUB2 side. In contrast, an upper surface of the spacer PSB arranged in the second display area DA2 is in contact with the second alignment film AL2 on the second substrate SUB2 side via the alignment film AL1. The spacer PSA arranged in the first display area DA1 may also be referred to as a sub-spacer. In addition, the spacer PSB arranged in the second display area DA2 may also be referred to as a main spacer.

In addition, as shown in FIG. 16, spacers PS in cross column arrangement, which include second spacers PS2 having different heights, may be arranged in the first display area DA1 and the second display area DA2. More specifically, a spacer PSA in cross column arrangement, including a second spacer PS2A which is smaller (lower) in height than a second spacer PS2B of the spacer PSB arranged in the second display area DA2, may be arranged in the first display area DA1 where the user's line of sight is easily concentrated, and a spacer PSB in cross column arrangement, including a second spacer PS2B which is larger (higher) in height than a spacer PS2A of the spacer PSA arranged in the first display area DA1, may be arranged in the second display area DA2 where the user's line of sight is rarely concentrated. In this case, the first spacer PS1A and the second spacer PS2A constituting the spacer PSA in cross column arrangement arranged in the first display area DA1 are not in contact with each other, but are separated from each other. In contrast, the first spacer PS1B and the second spacer PS2B constituting the spacer PSB in cross column arrangement arranged in the second display area DA2 are in contact with each other via the first alignment film AL1 and the second alignment film AL2.

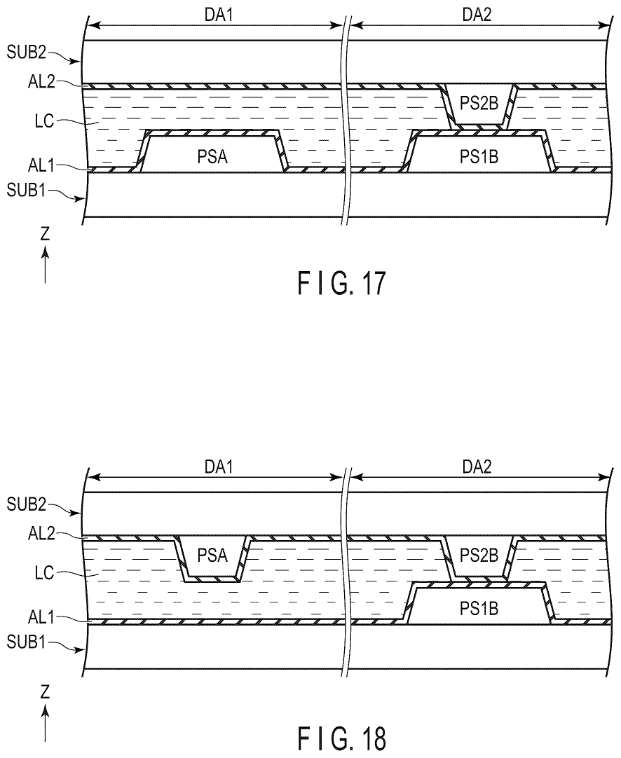

Furthermore, as shown in FIG. 17, the spacer PS may be arranged on the only first substrate SUB1 side in the first display area DA1 where the user's line of sight is easily concentrated, and the spacer PS in cross column arrangement (i.e., the spacer PS including the first spacer PS1 arranged on the first substrate SUB1 side and the second spacer PS2 arranged on the second substrate SUB2 side) may be arranged in the second display area DA2 where the user's line of sight is rarely concentrated. In this case, the spacer PSA arranged in the first display area DA1 is not in contact with the configuration on the second substrate SUB2 side, but is separated from the configuration on the second substrate SUB2 side. In contrast, the first spacer PS1B and the second spacer PS2B constituting the spacer PSB in cross column arrangement arranged in the second display area DA2 are in contact with each other via the first alignment film AL1 and the second alignment film AL2.

In addition, as shown in FIG. 18, the spacer PS may be arranged on the only second substrate SUB2 side in the first display area DA1 where the user's line of sight is easily concentrated, and the spacer PS in cross column arrangement (i.e., the spacer PS including the first spacer PS1 arranged on the first substrate SUB1 side and the second spacer PS2 arranged on the second substrate SUB2 side) may be arranged in the second display area DA2 where the user's line of sight is rarely concentrated. In this case, the spacer PSA arranged in the first display area DA1 is not in contact with the configuration on the first substrate SUB1 side, but is separated from the configuration on the first substrate SUB1 side. In contrast, the first spacer PS1B and the second spacer PS2B constituting the spacer PSB in cross column arrangement arranged in the second display area DA2 are in contact with each other via the first alignment film AL1 and the second alignment film AL2.

In the configurations shown in FIG. 14 to FIG. 18, too, similarly to the configurations shown in FIG. 11 to FIG. 13, even if the number of spacers PS (spacers PSB) arranged in the second display area DA2 is smaller than that in the configuration shown in FIG. 7, the gap between the first substrate SUB1 and the second substrate SUB2 can be held appropriately since the spacers (spacers PSA) are arranged in the first display area DA1. In addition, in the configurations shown in FIG. 14 to FIG. 18, too, similarly to the configurations shown in FIG. 11 to FIG. 13, since the number of spacers PS (spacers PSB) arranged in the second display area DA2 can be made smaller than that in the configuration shown in FIG. 7 as described above, the contrast ratio of the second display area DA2 can be improved more than that in the configuration shown in FIG. 7 while suppressing the degradation in contrast ratio of the first display area DA1 to the minimum limit. In other words, a difference between the display quality in the first display area DA1 and the display quality in the second display area DA2 can be reduced as compared with the configuration shown in FIG. 7.

In the display device DSP of the above-described embodiment, the spacers PS are arranged such that the density per unit area (arrangement density) of the spacers PS arranged in the first display area DA1 where the user's line of sight is easily concentrated is smaller than the density per unit area (arrangement density) of the spacers PS arranged in the second display area DA2 where the user's line of sight is rarely concentrated. According to this, the high-definition display device DSP used as a VR viewer, which can provide the user with high-quality display, can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate having a display area where a plurality of pixels are arranged;
a second substrate opposed to the first substrate;
a liquid crystal layer arranged between the first substrate and the second substrate; and
spacers holding a gap between the first substrate and the second substrate, wherein
the spacers are arranged in the display area,
the display area includes a first display area including a center of the display area and a second display area around the first display area, and
an arrangement density of the spacers in the first display area is smaller than an arrangement density of the spacers in the second display area.

2. The display device of claim 1, wherein
the spacers are not arranged in the first display area.

3. The display device of claim 1, wherein
number of the spacers arranged in the first display area is smaller than number of the spacers arranged in the second display area.

4. The display device of claim 1, wherein
a size of the spacers arranged in the first display area is smaller than a size of the spacers arranged in the second display area.

5. The display device of claim 4, wherein
a shape of the spacers arranged in the first display area is different from a shape of the spacers arranged in the second display area.

6. The display device of claim 5, wherein
a height of the spacers arranged in the first display area is lower than a height of the spacers arranged in the second display area.

7. The display device of claim 5, wherein
the spacers arranged in the first display area and the second display area include first spacers arranged on the first substrate side and second spacers arranged on the second substrate side, and
a height of the second spacer arranged in the first display area is lower than a height of the second spacer arranged in the second display area.

8. The display device of claim 5, wherein
the spacers arranged in the first display area are arranged on the first substrate side, and
the spacers arranged in the second display area include first spacers arranged on the first substrate side and second spacers arranged on the second substrate side.

9. The display device of claim 5, wherein
the spacers arranged in the first display area are arranged on the second substrate side, and
the spacers arranged in the second display area include first spacers arranged on the first substrate side and second spacers arranged on the second substrate side.

10. A head mount display comprising the display device of claim 1.

11. The head mount display of claim 10, wherein
the first display area is an area where a line of sight of a user wearing the head mount display is easily concentrated, and
the second display area is an area where a line of sight of a user wearing the head mount display is hardly concentrated.
